(19) United States
(12) Patent Application Publication
(10) Pub. No.: US 2006/0137210 A1
(43) Pub. Date: Jun. 29, 2006

(54) Drum-and-cabinet type dryer with length-adjustable shelf

(75) Inventors: Deug Hee Lee, Gimhae-si (KR); Hung Myong Cho, Jillye-myeon (KR); Byung Hwan Ahn, Gimhae-si (KR); Soung Bong Choi, Changwon-si (KR); Young Soo Kim, Changwon-si (KR)

Correspondence Address: MCKENNA LONG & ALDRIDGE LLP, 1900 K STREET, NW, WASHINGTON, DC, 20006, US

(73) Assignee: LG ELECTRONICS INC., Youngdungpo-gu (KR)

(21) Appl. No.: 11/289,637

(22) Filed: Nov. 30, 2005

(30) Foreign Application Priority Data
Nov. 30, 2004 (KR) 10-2004-99157

(51) Int. Cl. F26B 19/00; F26B 11/02; F26B 25/06

(52) U.S. Cl. 34/201; 34/60; 34/130

(57) ABSTRACT

A drum-and-cabinet type dryer is disclosed which is capable of continuously circulating air to dry laundry contained in a drying drum and laundry contained in a drying cabinet, and more efficiently using the inner space of the drying cabinet. The drum-and-cabinet type dryer includes a drum dryer which includes a drying drum adapted to receive the laundry, a hot air supplier adapted to generate hot air, and a hot air supply duct adapted to guide the hot air into the drying drum, a cabinet dryer which includes a body defined with a laundry receiving compartment, and a hot air introduction duct adapted to receive the hot air from the drum dryer, and to guide the received hot air into the laundry receiving compartment of the body, and a length-adjustable shelf which has an adjustable length, and is mounted to the body such that the shelf is arranged in the laundry receiving compartment.

This application claims the benefit of Korean Patent Application No. 10-2004-99157, filed on Nov. 30, 2004 which is hereby incorporated by reference as if fully set forth herein.

### BACKGROUND OF THE INVENTION

1. Field of the Invention

The present invention relates to a drying apparatus, and more particularly, to a drying apparatus which is capable of continuously circulating laundry-drying air through dryers while obtaining a more efficient drying effect, so that the composite washing system has a suitable built-in structure, and has minimal influence on the indoor environment.

2. Discussion of the Related Art

Generally, laundry dryers are adapted to dry laundry such as clothes. Such a laundry dryer receives completely-washed laundry, and then performs an operation to dry the laundry while continuously supplying hot air.

FIG. 1 illustrates a general drum dryer as an example of a conventional laundry dryer.

As shown in FIG. 1, the conventional drum dryer mainly includes a body 10, a drying drum 20, a door 40, a motor 50, a drying heater 60, and a blowing fan 70.

The body 10 defines an appearance of the drum dryer. The drying drum 20 is rotatably disposed in the body 10. A laundry inlet 11 is formed through the front of the body 10. The door 40 is mounted to the front of the body 10 to open and close the laundry inlet 11.

The motor 50 is fixedly mounted on the bottom of the body 10 inside the body 10. The motor 50 generates a drive force to rotate the drying drum 20 and the blowing fan 70.

The drying heater 60 is arranged in a hot air supply path 91 in order to heat air flowing through the hot air supply path 91. The hot air supply path 91 guides a flow of hot air supplied into the drying drum 20.

The blowing fan 70 operates to outwardly discharge the hot air, namely, drying air, flowing through the interior of the drying drum 10. The blowing fan 70 communicates with a hot air discharge path 92.

In accordance with the above-mentioned configuration, when the blowing fan 70 operates, air around the laundry dryer, namely, ambient air, is introduced into the body 10, is heated while passing through the drying heater 60, and is then introduced into the drying drum 20 while being guided by the hot air supply path 91.

Accordingly, wet laundry received in the drying drum 20 is gradually dried by the hot air.

The air used to dry the laundry while passing through the drying drum 10 is outwardly discharged while being guided by the hot air discharge path 92.

When the laundry is completely dried in accordance with repeated execution of the above-mentioned procedure, the operations of the blowing fan 70 and drying heater 60 are stopped to complete the drying cycle.

In the conventional drum dryer, however, there is a problem in that laundry is inefficiently dried because the drying cycle is carried out while the laundry is in an entangled state.

Furthermore, there is a problem in that the laundry cannot be maintained in the dryer.

To this end, a demand for a new laundry dryer has recently been made which has an increased drying capacity and enables storage of dried laundry for a prolonged period of time. To satisfy this demand, a combination type dryer has been developed, as disclosed in U.S. Published Patent Application Nos. 2004/0194339 A1 and 2004/0154194 A1. Such a combination type dryer includes a separate drying cabinet, in addition to a drum dryer, namely, a tumble dryer.

In such a combination type dryer, a drying cabinet, which has a drying compartment for various clothes, is mounted on the top of a general drum dryer having a rotatable drum such that hot air is supplied to the drying cabinet.

The drying cabinet receives hot air supplied from the drum dryer to dry clothes received in the drying cabinet. The drying cabinet may also be used to store the dried clothes for a prolonged period of time.

However, the above-mentioned combination type dryer has a problem in that it cannot be of a built-in type because it has an air discharge type structure in which the air used to dry laundry is outwardly discharged from the dryer.

In other words, where the combination type dryer is built in a wall, it is necessary to provide a sufficient built-in space to provide a sufficient gap from the surface of the wall such that air is adequately discharged away from the dryer. For this reason, the appearance of the dryer is unattractive.

Furthermore, the air discharged from the combination type dryer is hot and humid, thereby causing the indoor environment to be an environment undesirable for the user, namely, a high-temperature and humid environment.

In the drying cabinet, shelves and hangers are disposed to support laundry. However, only a limited amount of laundry is accommodatable by such shelves and hangers in the laundry compartment of the drying cabinet. For this reason, there is a problem in that it is impossible to efficiently use the laundry compartment of the drying cabinet.

For example, where the amount of laundry to use the hangers is larger than the amount of laundry to use the shelves, it is necessary to perform the drying cycle several times because the laundry compartment of the drying cabinet can fit only a limited number of hangers. In this case, accordingly, there is a problem of an increase in power consumption.

### SUMMARY OF THE INVENTION

Accordingly, the present invention is directed to a drum-and-cabinet type dryer with a length-adjustable shelf that substantially obviates one or more problems due to limitations and disadvantages of the related art.

An object of the present invention is to provide a drum-and-cabinet type dryer which is capable of continuously circulating air to dry laundry contained in a drying drum and laundry contained in a drying cabinet, and more efficiently using the inner space of the drying cabinet.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a drum-and-cabinet type dryer comprises: a drum dryer which includes a drying drum adapted to receive the laundry, a hot air supplier adapted to generate hot air, and a hot air supply duct adapted to guide the hot air into the drying drum; a cabinet dryer which includes a body defined with a laundry receiving compartment, and a hot air introduction duct adapted to receive the hot air from the drum dryer, and to guide the received hot air into the laundry receiving compartment of the body; and a length-adjustable shelf which has an adjustable length, and is mounted to the body such that the shelf is arranged in the laundry receiving compartment.

An article to be dried, namely, laundry, is received in the drum of the drum dryer. As hot air is supplied to the drum, the laundry is dried. Another laundry is received in the laundry receiving compartment of the body included in the cabinet dryer. The laundry in the laundry receiving compartment is dried in accordance with the supply of hot air to the laundry receiving compartment.

The drum dryer may further include a third hot air supply duct which guides air emerging from the drum into the hot air supplier, and the cabinet dryer further includes an air discharge duct which guides air emerging from the laundry receiving compartment of the body into the hot air supplier. Also, the drum-and-cabinet type dryer may further comprise a condenser which condenses moisture contained in the air guided into the hot air supplier. Accordingly, the air used to dry laundry is continuously circulated in the dryer without being discharged away from the dryer.

The drum-and-cabinet type dryer may further comprise a second hot air supply duct having a first end communicating with the hot air supplier, and a second end communicating with the first hot air supply duct and the hot air introduction duct. Accordingly, the hot air from the hot air supplier can be supplied to both the drum and the laundry receiving compartment of the body in a distributed manner.

A valve may be arranged at the second end of the second hot air supply duct connected to the first hot air supply duct and hot air introduction duct. Accordingly, the hot air from the second hot air supply duct can be guided into at least one of the first hot air supply duct and the hot air introduction duct.

Since particles may be contained in the air guided to the condenser, the drum-and-cabinet type dryer may further comprise a filter for filtering air guided to the condenser.

The length-adjustable shelf may be a foldable shelf in which one portion of the foldable shelf is foldable on the other portion of the foldable shelf to vary a length of the foldable shelf, or may be a shelf which is foldable in accordance with other methods.

In another aspect of the present invention, a drum-and-cabinet type dryer comprises: a drum dryer which dries laundry to be dried, and includes a drying drum adapted to receive the laundry, a hot air supply duct adapted to guide a flow of hot air, and a hot air supplier arranged in the hot air supply duct to generate the hot air; a cabinet dryer which is coupled to a top of the drum dryer, and is defined with a laundry receiving compartment, the cabinet dryer including a hot air introduction duct adapted to receive the hot air from the hot air supply duct; and a plurality of foldable shelves which are detachably mounted in the cabinet dryer, and are foldable to increase the utility of the laundry receiving compartment of the cabinet dryer.

Each of the foldable shelves may include a base which includes a first base member and a second base member, and supports laundry in such a manner that the laundry is laid on the base, a hinge member which hingably connects the first and second base members such that the second base member is foldable with respect to the first base member, and a fixing member which is fixed to one end of the second base member, to fix the foldable shelf in the cabinet dryer. A similar fixing member may also be provided at the first base member.

The fixing member fixed to the second base member may include a hollow fixing pipe which communicates with the hot air introduction duct. The fixing pipe may have a plurality of hot air outlets formed through a peripheral wall of the fixing pipe. The hot air guided through the hot air introduction duct may be introduced into the cabinet dryer through the hot air outlets.

The cabinet dryer may be arranged on the top of the drum dryer. In this case, the body of the cabinet dryer may include an extension causing the laundry receiving compartment to extend downwardly into the drum dryer. By virtue of the extension, clothes having a relatively long length, such as a coat, can fit in the laundry receiving compartment without being folded.

The drum-and-cabinet type drier according to the present invention has various advantages as follows.

First, air flowing in the drum dryer and cabinet dryer is continuously circulated without being discharged out of the dryers in accordance with the present invention. Accordingly, the air used in the drying cycle has no influence on the indoor environment. Therefore, the present invention can provide a composite washing system having a suitable built-in structure.

Second, in accordance with the present invention, humid air discharged from the drum dryer and cabinet dryer is condensed by the air condenser, so that moisture contained in the air is removed. Accordingly, it is possible to more effectively dry laundry.

Third, in accordance with the present invention, the cabinet dryer is equipped with the foldable shelves. Accordingly, it is possible to efficiently use the inner space of the cabinet dryer.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a schematic view illustrating an inner configuration of a conventional drum dryer;

FIG. 2 is a front view schematically illustrating an appearance of a drum-and-cabinet type dryer according to an exemplary embodiment of the present invention;

FIG. 3 is a cross-sectional view taken along the line I-I of FIG. 2;

FIG. 4 is a block diagram schematically illustrating the configuration of the composite washing system according to the exemplary embodiment of the present invention;

FIG. 5 is a perspective view illustrating a structure of a foldable shelf according to an exemplary embodiment of the present invention;

FIG. 6 is a perspective view illustrating a folded state of the foldable shelf according to the exemplary embodiment of the present invention; and

FIG. 7 is a front view schematically illustrating the foldable shelf which is in a folded state in the cabinet dryer in accordance with the exemplary embodiment of the present invention.

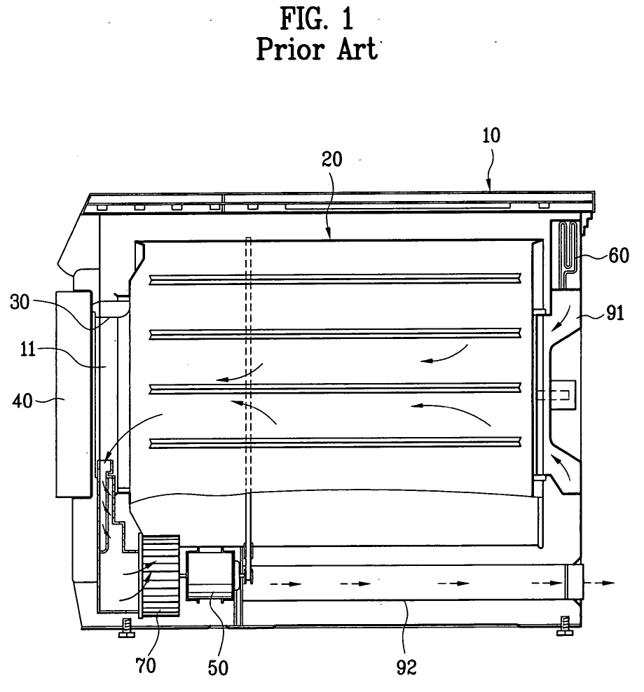

### DETAILED DESCRIPTION OF THE INVENTION

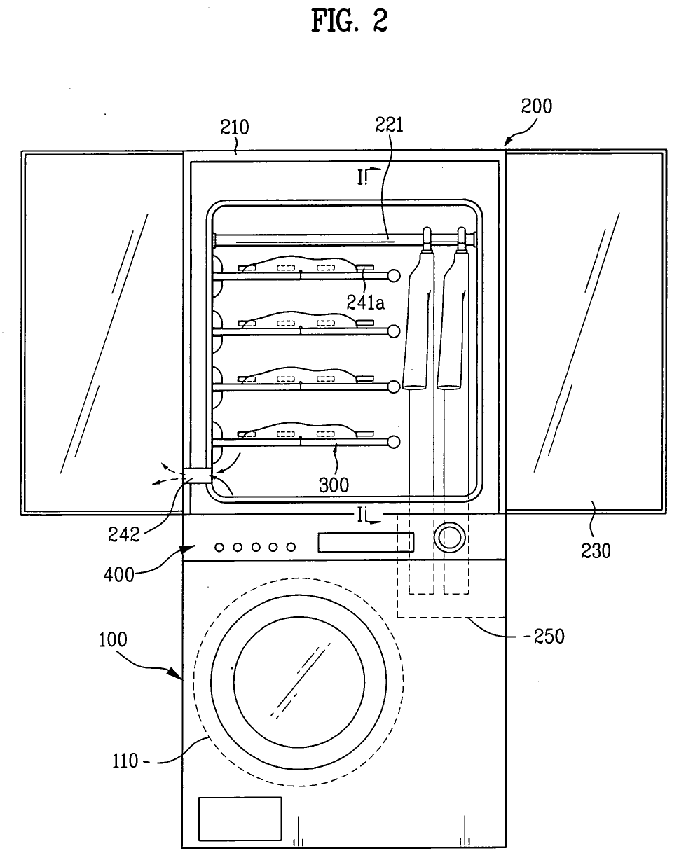

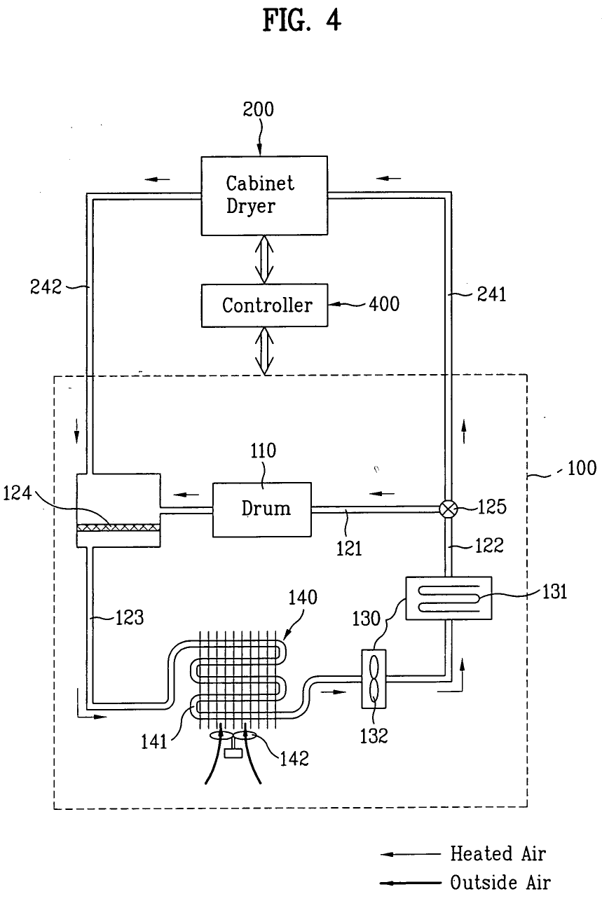

Reference will now be made in detail to the preferred embodiments of the present invention associated with a drying apparatus, examples of which are illustrated in the accompanying drawings, namely, FIGS. 2 to 7. Wherever possible, the same reference numbers will be used throughout the drawings to refer to the same or like parts.

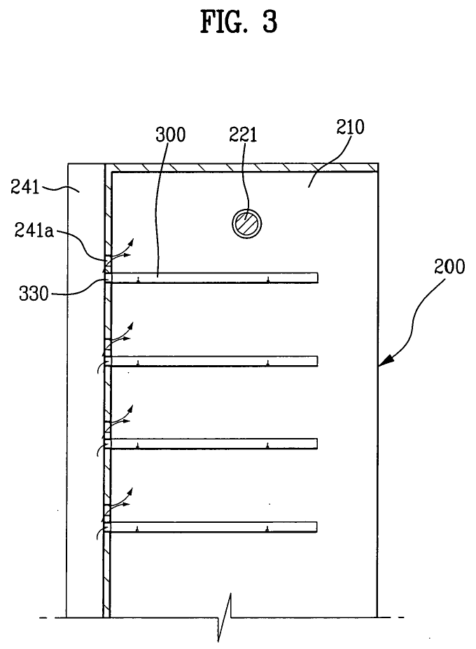

Referring to FIGS. 2 and 3, a drying apparatus according to an exemplary embodiment of the present invention is illustrated which may be of a drum-and-cabinet type. As shown in FIGS. 2 and 3, the drying apparatus mainly includes a drum dryer 100, a cabinet dryer 200, foldable shelves 300, and a controller 400.

The drum dryer 100 only performs an operation to dry laundry. The drum dryer 100 includes a drying drum 110 which can perform a rotating operation and a stirring operation, a hot air supply duct, a hot air supplier 130, and an air condenser 140.

The hot air supply duct is a duct to guide a flow of hot air. The hot air supply duct communicates with an inner space defined in the apparatus among the drying drum 110, air condenser 140, and cabinet dryer 200.

The hot air supply duct includes a first air supply duct 121 which supplies hot air into the drying drum 110, and a second air supply duct 122 which receives air emerging from the air condenser 140, and guides the received air into the first air supply duct 121. The hot air supply duct further includes a third air supply duct 123 which receives air emerging from the drying drum 110, and guides the received air into the air condenser 140.

A filter 124 is also arranged in the third air supply duct 123 to filter air passing through the third air supply duct 123, and thus, to remove particles contained in the air.

The hot air supplier 130 is arranged in the second air supply duct 122 to produce hot air.

The hot air supplier 130 includes a drying heater 131 which heats air passing through the second air supply duct 122, and a blowing fan 132 which forcibly blows the air heated in the second air supply duct 122.

Preferably, the blowing fan 132 is arranged in a portion of the second air supply duct 122 upstream from the drying heater 131, in order to minimize any damage to the blowing fan 132 caused by hot air.

The air condenser 140 condenses air flowing through the hot air supply duct, and radiates heat from the air. The air condenser 140 includes a condenser 141 and a condensing fan 142.

The condenser 141 is configured to receive hot air from the third air supply duct 123 of the hot air supply duct. The condenser 141 includes a pipe having a plurality of bent portions, and cooling fins arranged around the pipe.

The condensing fan 142 is adapted to blow external air toward the condenser 141.

Accordingly, humid air passing through the condenser 141 is condensed as it heat-exchanges with the external air supplied in accordance with the operation of the condensing fan 142 while passing through the pipe of the condenser 141.

The cabinet dryer 200 is defined with a laundry compartment to receive a large amount of laundry. The cabinet dryer 200 is coupled to the top of the drum dryer 100.

The cabinet dryer 200 mainly includes a body 210, a laundry support 220, an opening/closing door 230, a hot air introduction duct 241, and an air discharge duct 242.

The body 210 defines an appearance of the cabinet dryer 200, and is open at the front thereof.

Preferably, the body 210 includes a hollow extension 250 extending into the interior of the drum dryer 100.

The extension 250 allows laundry having a long length, such as a coat or trousers, to fit in the body 210 without coming into contact with the bottom of the body 210. As shown in FIG. 2, it is preferred that the extension 250 be arranged at one side of the body 210 such that the extension 250 does not interfere with the rotation of the drying drum 110 included in the drum dryer.

The opening/closing door 230 functions to open/close the open front of the body 210.

The hot air introduction duct 241 has one end connected to the second air supply duct 122 included in the hot air supply duct of the drum dryer 100, and the other end communicating with the interior of the body 210. Accordingly, the hot air introduction duct 241 receives hot air from the second air supply duct 122, and guides the received hot air into the body 210.

Preferably, a plurality of hot air outlets 241a are formed through the hot air introduction duct 241 such that the hot air outlets 241a communicate with the interior of the body 210 of the cabinet dryer.

Preferably, a valve 125 is arranged in the second supply duct 122 to guide the air flowing through the second air supply duct 122 toward the first air supply duct 121 and/or the hot air introduction duct 241.

The air discharge duct 242 has one end communicating with the body 210, and the other end connected to the third air supply duct 123 of the hot air supply duct. Accordingly, the air discharge duct 242 functions to discharge hot and humid air passing through the laundry in the body 210.

A hanger bar 221, on which hangers may be hung, is mounted in an inner upper portion of the body 210 such that the hanger bar 221 is arranged at one side of the body 210.

Each foldable shelf 300 is detachably mounted in the body 210 to support laundry in such a manner that the laundry is laid on the shelf 300. Each shelf 300 has a foldable structure to increase the utility of the laundry compartment of the cabinet dryer 200.

For example, when it is necessary to increase the space for laundry to be placed on hangers because the amount of the laundry to be hung is larger than the amount of the laundry to be placed on shelves, the foldable shelves 300 may be folded to reduce the shelf space, and thus, to increase the hanger space.

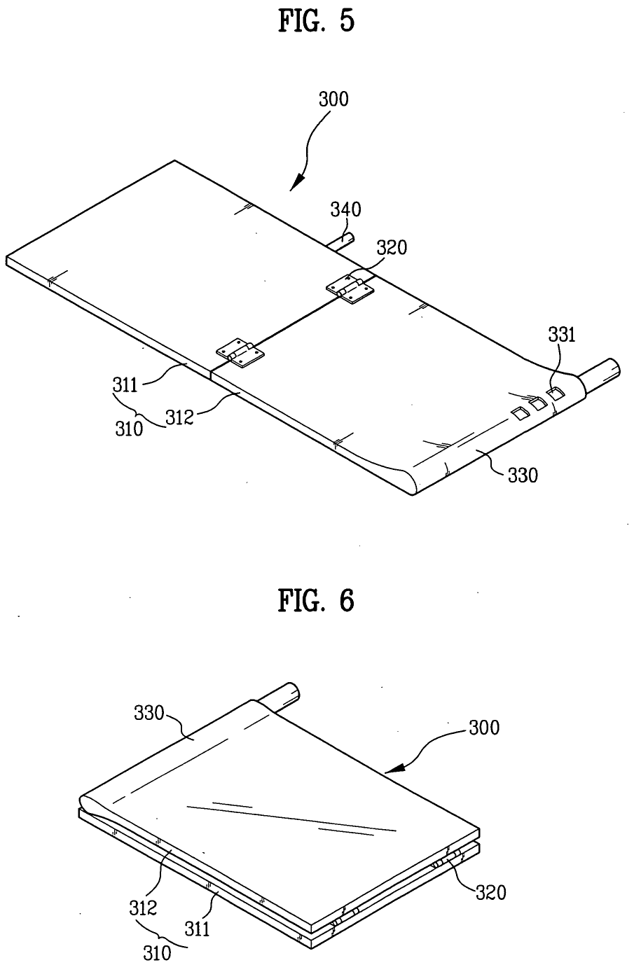

As shown in FIGS. 5 and 6, each foldable shelf 300 includes a base 310 which includes a first base member 311 and a second base member 312, hinge members 320 which hingably connect the first and second base members 311 and 312 such that the second base member 312 is foldable with respect to the first base member 311, and a fixing pipe 330 which is fixed to one end of the second base member 312, and can fit into a fitting hole formed through the body 210 of the cabinet dryer 200 to fix the foldable shelf 300 to the body 210.

Preferably, each foldable shelf 300 also includes a support lug 340 which is mounted to the first base member 311 to support the first base member 311 in a state in which the second base member 312 is folded on the first base member 311.

Preferably, fitting grooves (not shown) are formed at the rear of the body 210 of the cabinet dryer 200. The support lug 340 of each foldable shelf 300 can fit into an associated one of the fitting grooves.

It is preferred that the fixing pipe 330 of each foldable shelf 300 communicate with the hot air introduction duct 241, as shown in FIG. 3.

At least one hot air outlet 331 is formed through a peripheral wall of the fixing pipe 330, in order to supply hot air introduced into the fixing pipe 330 directly to laundry, and thus, to more effectively dry the laundry.

The controller 400 according to the exemplary embodiment of the present invention controls the operations of the drum dryer 100 and cabinet dryer 200.

The controller 400 may be equipped in one of the drum dryer 100 and cabinet dryer 200, or may be equipped in either the drum dryer 100 or the cabinet dryer 200. In the exemplary embodiment of the present invention, the controller 400 is illustrated as being equipped in the drum dryer 100.

Where two controllers 400 are equipped in the drum dryer 100 and cabinet dryer 200, respectively, it is preferred that the two controllers 400 be connected by a data cable (not shown), for information transfer therebetween.

Meanwhile, the controller 400 may be configured to control the drum dryer 100 and cabinet dryer 200 in an independent manner or in a linked manner.

Hereinafter, the drying operation and functions of the cabinet dryer equipped with the foldable shelves in accordance with the exemplary embodiment of the present invention will be described.

First, laundry is laid on the foldable shelves 300, or is hung on the hanger bar 221 in the body 210 of the cabinet dryer 200.

Thereafter, electric power is supplied to the hot air supplier 130, thereby causing hot air to be supplied to the second air supply duct 122 of the hot air supply duct.

Subsequently, the valve 125 is controlled to guide the hot air flowing through the second air supply duct 122 into the hot air introduction duct 241 of the cabinet dryer 200.

In this case, a part of the hot air flowing through the hot air introduction duct 241 is introduced into the body 210 of the cabinet dryer 200 through the hot air outlets 241a, and the remaining part of the hot air is introduced into the fixing pipes 330 of the foldable shelves 300.

The hot air introduced into the body 210 dries the laundry disposed in the body 210. The hot air introduced into each fixing pipe 330 is discharged through the associated hot air outlets 331, thereby drying the laundry laid on the associated foldable shelf 300.

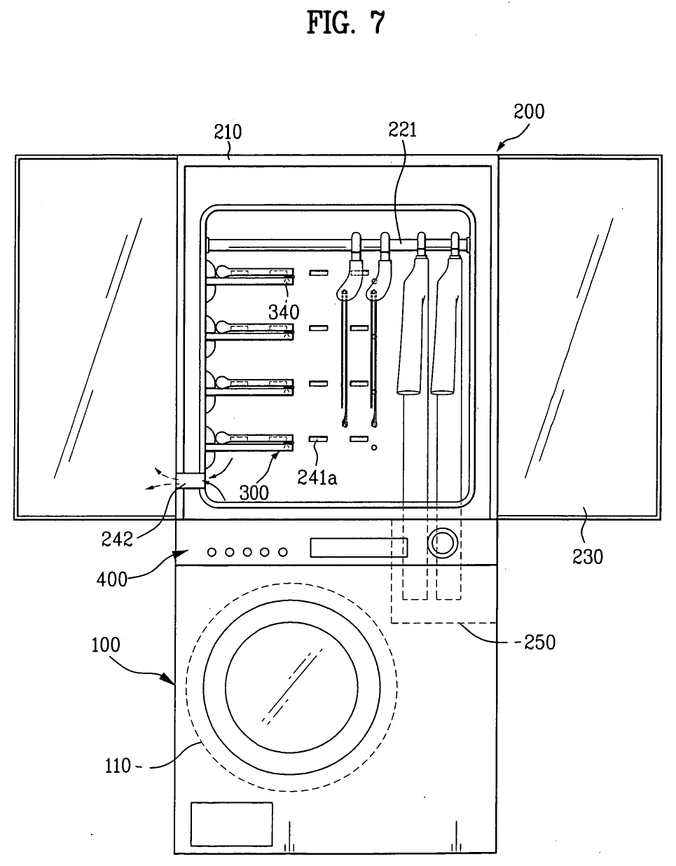

Meanwhile, where the amount of laundry to be dried while being hung on the hangers is larger than the amount of laundry to be dried while being laid on the shelves 300, the shelves 300 are used in a folded state, as shown in FIG. 7.

That is, when the second base member 312 of each shelf 300 is hinged about the hinge members 320 such that the second base member 312 folded on the first base member 311, an additional hanger space corresponding to the space for the second base member 312 is secured to allow an increased number of hangers to be hung on the hanger bar 221, and thus, to allow an increased amount of laundry to be dried in a hung state.

The air which has become humid after being used to dry the laundry is then introduced into the third air supply duct 123 via the air discharge duct 242 connected to one side of the body 210 of the cabinet dryer 200.

The humid air introduced into the third air supply duct 123 passes through the condenser 140, so that the air is dried while being condensed to remove moisture therefrom. The dried air is then heated to a high temperature while passing through the drying heater 131. The resultant hot air is then re-supplied to the body 210 of the cabinet dryer 200.

Thus, the laundry is dried as the above-described air flow is repeated for a predetermined time.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A drum-and-cabinet type dryer comprising:
a drum dryer which dries laundry to be dried, and includes a drying drum adapted to receive the laundry, a hot air supply duct adapted to guide a flow of hot air, and a hot air supplier arranged in the hot air supply duct to generate the hot air;
a cabinet dryer which is coupled to a top of the drum dryer, and is defined with a laundry receiving compartment, the cabinet dryer including a hot air introduction duct adapted to receive the hot air from the hot air supply duct; and
a plurality of foldable shelves which are detachably mounted in the cabinet dryer, and are foldable to increase the utility of the laundry receiving compartment of the cabinet dryer.

2. The drum-and-cabinet type dryer according to claim 1, wherein each of the foldable shelves includes:
a base which includes a first base member and a second base member, and supports laundry in such a manner that the laundry is laid on the base;
a hinge member which hingably connects the first and second base members such that the second base member is foldable with respect to the first base member; and
a fixing member which is fixed to one end of the second base member, to fix the foldable shelf in the cabinet dryer.

3. The drum-and-cabinet type dryer according to claim 2, wherein each of the foldable shelves further includes a support lug which is mounted to the first base member to support the first base member in a state in which the second base member is folded on the first base member.

4. The drum-and-cabinet type dryer according to claim 2, wherein the fixing member fixed to the second base member includes a hollow fixing pipe which communicates with the hot air introduction duct.

5. The drum-and-cabinet type dryer according to claim 4, wherein the fixing pipe has a plurality of hot air outlets formed through a peripheral wall of the fixing pipe.

6. A drum-and-cabinet type dryer comprising:
a drum dryer which includes a drying drum adapted to receive the laundry, a hot air supplier adapted to generate hot air, and a hot air supply duct adapted to guide the hot air into the drying drum;
a cabinet dryer which includes a body defined with a laundry receiving compartment, and a hot air introduction duct adapted to receive the hot air from the drum dryer, and to guide the received hot air into the laundry receiving compartment of the body; and
a length-adjustable shelf which has an adjustable length, and is mounted to the body such that the shelf is arranged in the laundry receiving compartment.

7. The drum-and-cabinet type dryer according to claim 6, wherein the drum dryer further includes a third hot air supply duct which guides air emerging from the drum into the hot air supplier, and the cabinet dryer further includes an air discharge duct which guides air emerging from the laundry receiving compartment of the body into the hot air supplier,
further comprising a condenser which condenses moisture contained in the air guided into the hot air supplier.

8. The drum-and-cabinet type dryer according to claim 7, further comprising:
a second hot air supply duct having a first end communicating with the hot air supplier, and a second end communicating with the first hot air supply duct and the hot air introduction duct.

9. The drum-and-cabinet type dryer according to claim 8, further comprising:
a valve which is arranged at the second end of the second hot air supply duct to guide the hot air from the second hot air supply duct into at least one of the first hot air supply duct and the hot air introduction duct.

10. The drum-and-cabinet type dryer according to claim 9, further comprising:
a filter for filtering air guided to the condenser.

11. The drum-and-cabinet type dryer according to claim 7, wherein the length-adjustable shelf is a foldable shelf in which one portion of the foldable shelf is foldable on the other portion of the foldable shelf to vary a length of the foldable shelf.

12. The drum-and-cabinet type dryer according to claim 11, wherein the foldable shelf includes:
a base which includes a first base member and a second base member, and supports laundry in such a manner that the laundry is laid on the base;
a hinge member which hingably connects the first and second base members such that the second base member is foldable with respect to the first base member; and
a fixing member which is fixed to one end of the second base member, to fix the foldable shelf in the cabinet dryer.

13. The drum-and-cabinet type dryer according to claim 12, wherein the foldable shelf further includes a support lug which is mounted to the first base member to support the first base member in a state in which the second base member is folded on the first base member.

14. The drum-and-cabinet type dryer according to claim 12, wherein the fixing member fixed to the second base member includes a hollow fixing pipe which communicates with the hot air introduction duct.

15. The drum-and-cabinet type dryer according to claim 14, wherein the fixing pipe has a plurality of hot air outlets formed through a peripheral wall of the fixing pipe.

16. The drum-and-cabinet type dryer according to claim 6, wherein:
the cabinet dryer is arranged on a top of the drum dryer; and
the body of the cabinet dryer includes an extension causing the laundry receiving compartment to extend downwardly into the drum dryer.
